(19) United States
(12) Patent Application Publication
(10) Pub. No.: US 2005/0030845 A1
(43) Pub. Date: Feb. 10, 2005

(54) Focus control method of optical pick-up system and apparatus thereof

(75) Inventors: Sang Cheon Kim, Gyeonggi-Do (KR); See Hyung Lee, Gyeonggi-Do (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/912,607

(22) Filed: Aug. 4, 2004

(30) Foreign Application Priority Data
Aug. 5, 2003 (KR) 2003-0054200

(51) Int. Cl. G11B 7/00

(52) U.S. Cl. 369/44.26; 369/44.25

(57) ABSTRACT

Disclosed is a focus control method of an optical pick-up system and an apparatus thereof capable of finely recording/reproducing data by focusing a laser beam on an optical disc accurately even if a component of an optical pick-up system is defective, an assembling error occurs, and a thickness of an optical disc is not uniform. To this end, the present invention is achieved by irradiating an optical beam onto an optical recording media having a reference mark through an objective lens of an optical pick-up system and moving the objective lens or a collimator lens of the optical pick-up system on the basis of an optical signal reflected by a reference mark of the optical recording media.

### BACKGROUND OF THE INVENTION

1. Field of the Invention

The present invention relates to an optical disc drive, and particularly, to a focus control method of an optical pick-up system of an optical disc drive and an apparatus thereof.

2. Description of the Prior Art

The progress of informatization in the entire industrial field in recent years is making demands for a device such as an optical recording media which can store a text, high definition image information, sound information of good sound quality or the like and an optical disc drive for reading the optical recording media.

FIG. 1 is a view showing a structure of a far field optical pick-up system of a general optical disc drive.

As shown therein, a far field optical pick-up system changes a laser beam 2, which is irradiated from a laser light source 1 such as a laser diode (not shown) or the like, to parallel light through a collimator lens 3, and converges the parallel light on an optical disc 9 through a beam splitter 4, a mirror 5 and an objective lens (OL) 7. In addition, the optical pick-up system acquires an optical signal reflected from the optical disc 9 through the objective lens (OL) 7, the mirror 5 and the beam splitter 4. And, an optical disc drive converts the optical signal transmitted from the optical pick-up system to an electrical signal, and reproduces data stored in the optical disc 9 based on the electrical signal. Here, the optical disc 9 is rotated by a spindle motor 10, and the objective lens 7 is moved by a micro actuator 8.

To control a focus which is deviated due to run-out generated while an optical disc 9 rotates, a position of the objective lens 7 is changed by using a voice coil motor 11 mounted at the far field optical pick-up system.

FIG. 2 is a view showing a structure of a general near field (NF) optical pick-up system.

As shown therein, a near field optical pick-up system changes a laser beam 2 irradiated from a laser light source 1 such as a laser diode or the like to parallel light through a collimator lens 3, guides the parallel light to a beam splitter 4, a mirror 5, an objective lens 7 and a solid immersion lens (SIL) 13, and converges the guided parallel light on the optical disc 9. In addition, the near field optical pick-up system acquires an optical signal reflected from the optical disc 9 through the solid immersion lens 13, the objective lens 7, the mirror 5 and the beam splitter 4, and the optical disc drive reproduces data stored in the optical disc 9 based on the optical signal.

By using a solid immersion lens (SIL) 13, a near-field optical system implementing a near field technology overcomes the diffraction limit of a general far-field optical system applied to an optical disc, thereby recording data on an optical disc at high density or reproducing data of the optical disc.

However, in a system that a focus servo operation is not performed or a system that an objective lens is mounted to a flying head like the optical pick-up system in accordance with the conventional art, the flying head, namely, a slider 12 is fabricated to be lifted by air so as to maintain a constant interval between itself and the optical disc 9.

Accordingly, the optical pick-up system in accordance with the conventional art has a problem that a laser beam cannot be focused on a recording layer of an optical disc accurately when a thickness of the optical disc is not uniform due to an inconstant thickness of a protective layer of the optical disc or when a component of the optical pick-up system is defective.

In addition, a laser beam cannot be focused on a recording layer of an optical disc accurately due to deterioration of elements such as the laser diode or the like or deformation or distortion of adhesives for fixing components of the optical pick-up system.

Consequently, if a laser beam cannot be focused on an optical disc accurately, the beam size focused on the optical disc becomes great, which causes performance deterioration in an optical pick-up system, inaccurate tracking of the optical disc, and inaccurate reproduction of data recorded on the optical disc 9.

An optical disc drive in accordance with the conventional art is disclosed in the specifications of U.S. Pat. No. 5,737,289, No. 6,741,539 and No. 6,738,327.

### SUMMARY OF THE INVENTION

Therefore, an object of the present invention is to provide a focus control method of an optical pick-up system and an apparatus thereof capable of finely recording/reproducing data by focusing a laser beam on an optical disc accurately by using a reference mark formed on the optical disc even if a component of the optical pick-up system is defective, an assembling error occurs, and a thickness of the optical disc is not uniform.

To achieve these and other advantages and in accordance with the purpose of the present invention, as embodied and broadly described herein, there is provided a focus control method of an optical pick-up system comprising: irradiating an optical beam onto an optical recording media having a reference mark through an objective lens of an optical pick-up system; and moving the objective lens or a collimator lens of the optical pick-up system on the basis of an optical signal reflected by the reference mark of the optical recording media.

To achieve these and other advantages and in accordance with the purpose of the present invention, as embodied and broadly described herein, there is provided a focus control method of an optical pick-up system comprising: positioning an optical recording medial on which a reference mark is formed under an objective lens of an optical pick-up system; irradiating an optical beam onto the optical recording media through the objective lens while rotating the optical recording media; analyzing an optical signal reflected by a reference mark of the optical recording media; and focusing the optical beam on an information recording surface of the optical recording media by moving the objective lens or a collimator lens of the optical pick-up system on the basis of the analyzed optical signal.

To achieve these and other advantages and in accordance with the purpose of the present invention, as embodied and broadly described herein, there is provided a focus control method of an optical pick-up system comprising: positioning an optical disc having a reference mark formed radially under an objective lens of an optical pick-up system; irradiating an optical beam onto the optical disc through the objective lens while rotating the optical recording media; determining whether an optical signal reflected by the reference mark of the optical disc is normal; determining the optical signal to be normal if a variation rate of an electrical signal corresponding to the optical signal is equal to or greater than a preset reference value; and moving the objective lens up and down, or moving the collimator lens of the optical pick-up system right and left if the variation rate of an electrical signal corresponding to the optical signal is smaller than the preset reference variation rate value, so that a variation rate of an electrical signal corresponding to the optical beam becomes equal to or greater than the preset reference variation rate value.

To achieve these and other advantages and in accordance with the purpose of the present invention, as embodied and broadly described herein, there is provided an optical pick-up system installed at an optical disc drive for recording/reproducing an optical recording media and having a laser diode, a collimator lens, a beam splitter, a mirror, an objective lens and a solid immersion lens, comprising: a controller for generating a control signal for moving the collimator lens so that a variation rate of an electrical signal corresponding to an optical signal reflected by a reference mark formed on the optical recording media is equal to or greater than a preset reference variation rate value; and an actuator for moving the collimator lens according to the control signal.

To achieve these and other advantages and in accordance with the purpose of the present invention, as embodied and broadly described herein, there is provided a focus control apparatus of an optical pick-up system comprising: a controller for generating a control signal for moving a collimator lens of an optical pick-up system so that a value of an electrical signal corresponding to an optical signal reflected by a reference mark formed on an optical recording media is equal to or greater than a preset reference value; and an actuator for moving the collimator lens according to the control signal

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a view showing a structure of a far field optical pick-up system of a general optical disc drive;

FIG. 2 is a view showing a structure of a general near field (NF) optical pick-up system;

FIG. 3 is view showing a structure of an optical disc drive employing a focus control method in accordance with the present invention;

FIG. 4 is a flow chart showing a focus control method of an optical pickup system in accordance with the present invention;

FIGS. 5A to 5C are views showing reference marks formed on an optical disc in accordance with the present invention;

FIG. 6 is a graph constructed from a measurement of an electrical signal (voltage wave form) corresponding to an optical signal reflected by a reference mark formed on an optical disc in accordance with the present invention; and

FIG. 7 is a graph constructed from a measurement of an electrical signal corresponding to an optical signal reflected by a reference mark formed on an optical disc while the optical disc is being rotated.

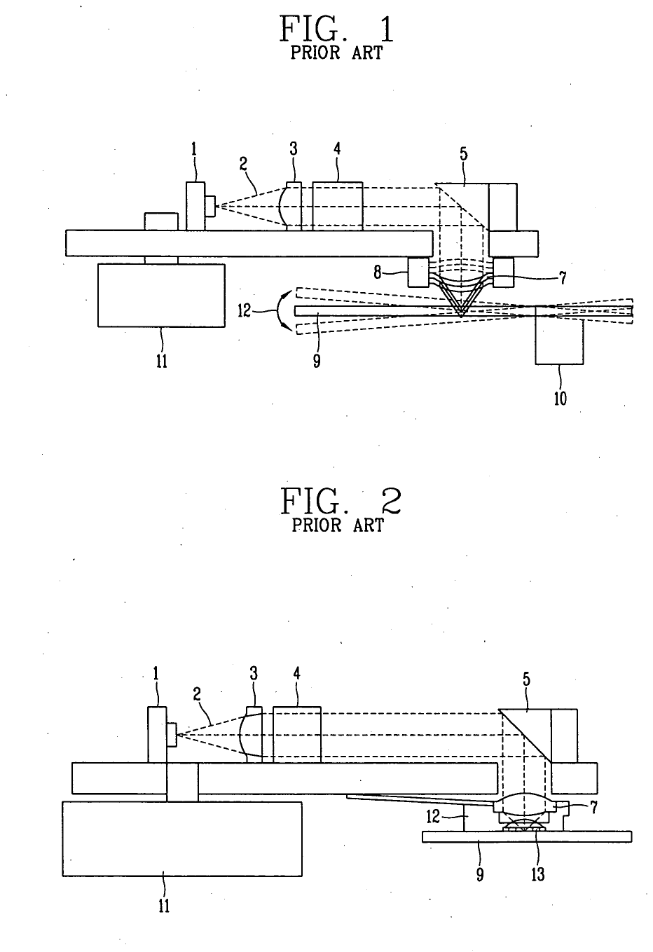

### DETAILED DESCRIPTION OF THE PREFERRED EMBODIMENTS

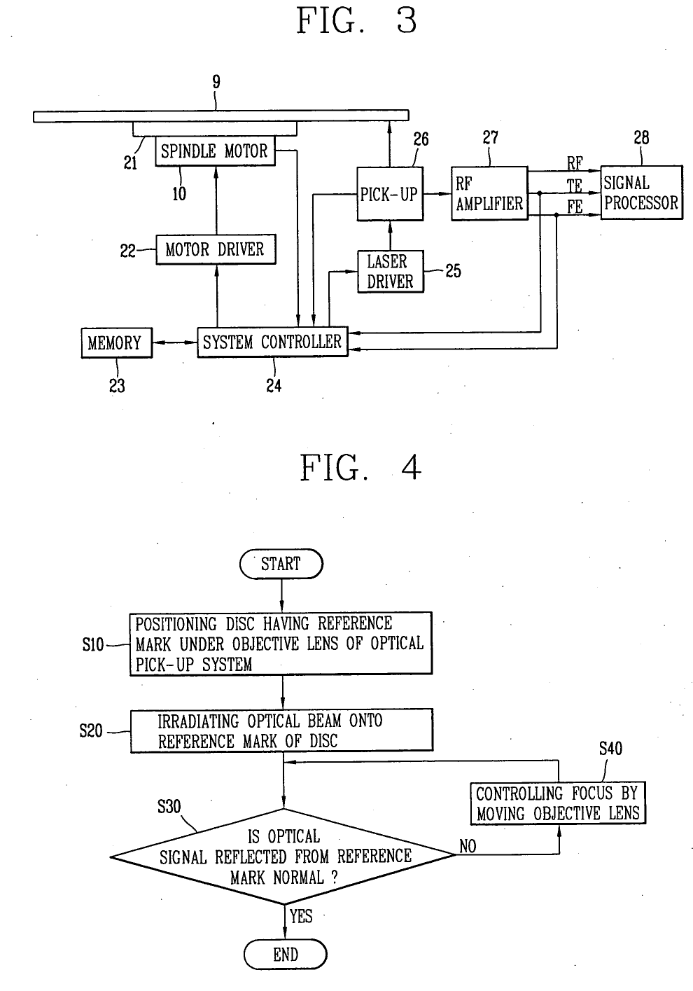

Hereinafter, the preferred embodiment of a focus control method of an optical pick-up system and an apparatus thereof capable of finely recording/reproducing data by focusing a laser beam on an optical disc accurately by using a reference mark formed on the optical disc even if a component of the optical pick-up system is defective, an assembling error occurs, and a thickness of the optical disc is not uniform, will now be described with reference to FIGS. 3 to 7 in detail. As for a structure of the present invention, which is identical with that of the conventional art, the present invention will be described by using the reference numerals of the structure in accordance with the conventional art.

FIG. 3 is a view showing a structure of an optical disc drive employing a focus control method in accordance with the present invention.

As shown therein, the optical disc drive includes a spindle motor 10 for rotating an optical disc (optical recording media) 9 mounted at a turn table 21; a motor driver 22 for controlling the spindle motor 10; a pick-up system 26 for irradiating laser beams onto an optical disc 9 through a laser diode (not shown), and converting an optical signal reflected from the optical disc 9 into an electrical signal; an RF amplifier 27 for converting the electrical signal (current) outputted from the optical pick-up system 26 into a voltage, and generating a radio frequency (RF) signal, a tracking error (TE) signal and a focus error (FE) signal on the basis of the converted voltage; a signal processor 28 for reproducing data stored on the optical disc 9 on the basis of the RF signal, the TE signal and the FE signal; a laser driver 25 for generating a driving current for laser beam generation of the laser diode of the pick-up system 26; a system controller 24 for detecting rotation information of the spindle motor 10 on the basis of an FG pulse signal outputted from the spindle motor 10, controlling the motor driver 22 on the basis of the rotation information so that the spindle motor 10 is driven at a desired rotation speed, controlling tracking and focusing of the optical disc 9 on the basis of the TE signal, the FE signal outputted from the RF amplifier 27, and determining on the basis of the TE signal or the FE signal whether there is a crack on the optical disc; and a memory 23 for storing various programs and data for driving the optical disc drive.

The pick-up system 26 irradiates an optical beam onto an optical disc having a reference mark, and moves the objective lens 7 up and down on the basis of an optical signal reflected by the reference mark of the optical disc. For instance, the pick system 26 accurately controls a focus of the objective lens 7 by moving the objective lens 7 up and down so that a variation rate of an electrical signal corresponding to an optical signal reflected by the reference mark formed on the optical disc is not smaller than a preset reference value.

Hereinafter, because the operation of the optical disc drive is the same as the conventional art, detailed descriptions thereon will be omitted, and a focus control method of an optical pick-up system in accordance with the present invention will be described in detail with reference to FIG. 4.

FIG. 4 is a flow chart showing a focus control method of the optical pick-up system in accordance with the present invention.

First, an optical disc 9 on which a reference mark is formed is provided, and is positioned under an objective lens 7 of an optical pick-up system 26 (S10). Here, the reference mark may be formed on the optical disc 9 in various record patterns through various methods.

Thereafter, the optical pick-up system 26 irradiates an optical beam onto a reference mark of the optical disc 9 through the objective lens 7 according to a control signal of the system controller 24 (S20).

The optical pick-up system 26 receives an optical signal reflected by the reference mark, and transmits the received optical signal to the system controller 24.

The system controller 24 analyzes the optical signal, and determines whether the optical signal reflected by the reference mark is normal (S30). For example, if a value of an electrical signal corresponding to the optical signal reflected by the reference mark is equal to or greater than a preset reference value, the system controller 24 determines that the optical signal is normal. At this time, an optical signal is preferably irradiated on the optical disc which is rotating. Here, the reference mark means a record pattern preformed on the optical disc 9 so that an optical signal corresponding to a preset reference value is generated from the optical disc 9. That is, an optical signal reflected by the reference mark is converted into an electrical signal, a value of the electrical signal is compared to a preset reference value, and, if the value of the electrical signal is not smaller than the preset reference value, the optical signal reflected by the optical disc 9 is determined to be normal. Here, only if the value of the electrical signal is not smaller than the preset reference value, an optical beam is accurately focused on the optical disc 9.

On the contrary, if a value of an electrical signal corresponding to an optical signal reflected by the reference mark is smaller than a preset reference value, the system controller 24 outputs a control signal for moving the objective lens up and down to the optical pick-up system 26 until the value of the electrical signal corresponding to the optical signal reflected by the reference mark becomes equal to or greater than the preset reference value. That is, a control signal for moving the objective lens 7 up and down is outputted to the optical pick-up system 26 so that an optical spot of an optical beam having passed through the objective lens 7 is focused on an information recording surface of the optical disc.

The optical pick-up system 26 accurately controls a focus of the objective lens 7 by moving the objective lens 7 up and down according to the control signal. At this time, if a value of an electrical signal corresponding to an optical signal reflected by the reference mark of the optical disc 9 becomes equal to or greater than the preset reference value while the objective lens 7 is being moved up and down through the optical pick-up system 26, the system controller 24 outputs a control signal for stopping the movement of the objective lens 7 to the optical pick-up system 26. Here, preferably, the objective lens 7 is moved up and down by controlling a micro-actuator 8 mounted at the objective lens 7 (S40).

The optical pick-up system 26 stops the movement of the objective lens according to a control signal for stopping the movement of the objective lens 7.

Thereafter, when a focus of the objective lens 7 is controlled, the optical disc drive reproduces data of the optical disc 9 or records data on the optical disc according to an optical disc reproducing/recording method.

Instead of the system controller 24 for analyzing the optical signal and determining whether an optical signal reflected by the reference mark is normal, a special controller (not shown) may be installed at the optical pick-up system 26.

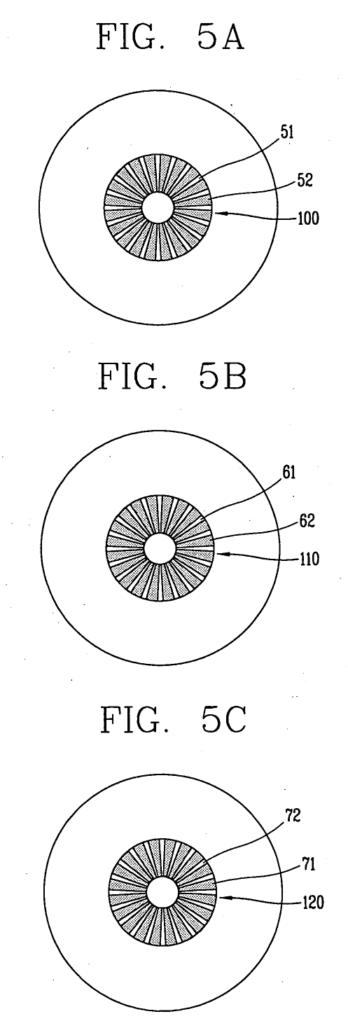

Hereinafter, reference marks which may be formed on the optical disc in various record patterns through various methods will now be described in detail with reference to FIGS. 5A to 5C.

FIGS. 5A to 5C are views showing reference marks formed on one portion of an optical disc in accordance with the present invention. The reference mark is preferably formed in a radial-type pattern on one portion of an information recording surface of the optical disc. That is, in order that the optical pick-up system 26 easily reads an optical signal reflected by a record pattern of the reference mark without performing servo tracking, the reference mark is preferably formed in a radial-type pattern on one portion of an information recording surface of the optical disc.

As shown in FIG. 5A, in case that a recording/reproducing system such as a magneto-optic (MO) type is applied to an optical pick-up system, record patterns formed such that their magnetization direction is alternately upward and downward are formed as a radial-type pattern on one portion of the optical disc, thereby forming a reference mark 100. In FIG. 5A, a non-hatching region is a region 51 where the magnetization direction is upward, and a hatching region is a region 52 where the magnetization direction is downward.

As shown in FIG. 5B, in case that a phase change system is applied to an optical pick-up system, record patterns formed such that their reflectivity is alternately high and low are formed as a radial-type pattern on one portion of the optical disc, thereby forming a reference mark 110. In FIG. 5B, a non-hatching region is a region 61 where the reflectivity is high, and a hatching region is a region 62 where the reflectivity is low.

As shown in FIG. 5C, in case that an optical disc is a CD-ROM (Compact Disc Read Only Memory), record patterns formed such that bright and dark regions are alternately formed are formed as a radial-type pattern on one portion of the CD-ROM, thereby forming a reference mark 120. In FIG. 5C, a hatching region is a bright region 71, and a non-hatching region is a dark region 72.

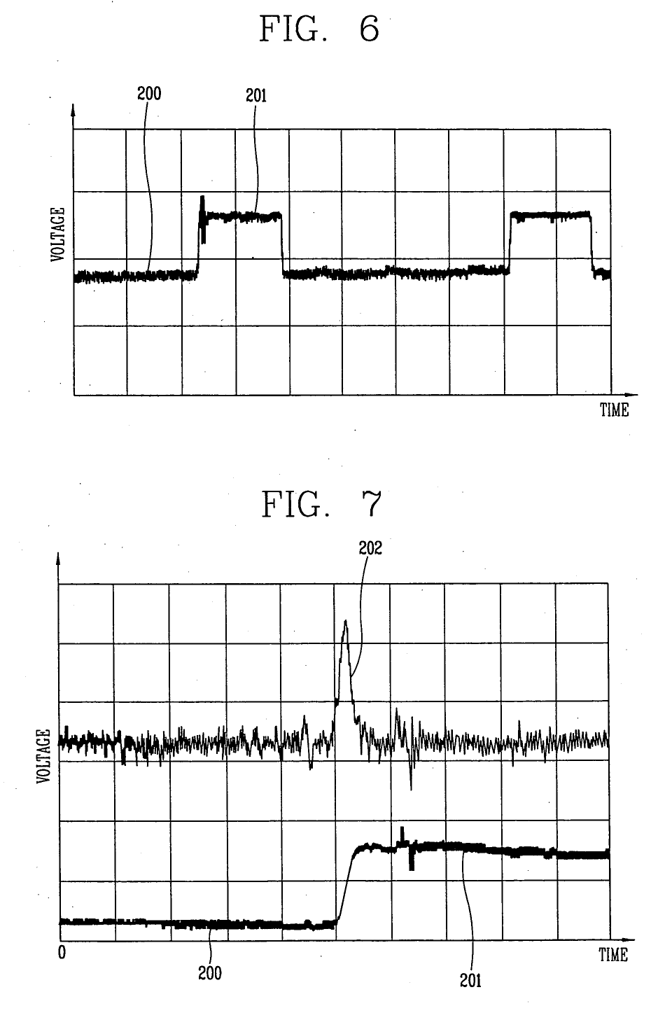

Hereinafter, an electrical signal (voltage wave form) corresponding to an optical signal reflected by a reference mark formed on the optical disc will now be described in detail with reference to FIG. 6.

FIG. 6 is a graph constructed from a measurement of an electrical signal (voltage wave form) corresponding to an optical signal reflected by a reference mark formed on an optical disc in accordance with the present invention.

As shown therein, an electrical signal corresponding to an optical signal reflected by the region where the magnetization direction is upward, the region where the reflectivity is high, and the bright region is represented as a square wave (high voltage) 201. And, an electrical signal corresponding to an optical signal reflected by the region where the magnetization direction is downward, the region where the reflectivity is low, and the dark region is represented as a low wave form (low voltage) 200.

FIG. 7 is a graph constructed from a measurement of an electrical signal corresponding to an optical signal reflected by a reference mark formed on an optical disc in accordance with the present invention while the optical disc is being rotated and a measurement of a variation rate of the electrical signal.

As shown therein, a value of an electrical signal (voltage) 200, 201, which corresponds to an optical signal reflected by a reference mark, is varied according to a pattern of the reference mark. For example, an electrical signal (voltage) 200 corresponding to an optical signal reflected by the region where the magnetization direction is downward is represented to be low, but an electrical signal (voltage) 201 corresponding to an optical signal reflected by the region where the magnetization direction is upward is represented to be high. That is, the objective lens can be accurately focalized by moving the objective lens up and down so that a value of the electrical signal is not smaller than the preset reference value, thereby accurately focalizing the objective lens.

‘202’ of FIG. 7 is a graph showing a variation rate of an electrical signal corresponding to an optical signal reflected by a reference mark over time. That is, when an optical beam is accurately focused on an information recording surface of an optical disc, an electrical signal corresponding to an optical signal is represented as a peak wave form 202.

Accordingly, in the present invention, when a variation rate of an electrical signal corresponding to an optical signal reflected by a reference mark of an optical disc is equal to or greater than a preset reference variation rate value, the optical beam is preferably determined to be accurately focused on an information recording surface of the optical disc.

In addition, a focus of the objective lens is controlled by moving the objective lens up and down so that a variation rate of an electrical signal corresponding to an optical signal reflected by a reference mark of an optical disc is not smaller than a preset reference variation rate value. That is, in order to position an optical spot of a laser beam of the objective lens on an information recording surface of an optical disc, the objective lens is moved up and down, whereby the variation rate of the electrical signal corresponding to the optical signal becomes equal to or greater than the preset reference variation rate value. Here, the preset reference value means a value of an electrical signal corresponding to an optical signal reflected by a reference mark formed on the optical disc when the optical spot is accurately focused on the information recording surface of the optical disc. And, the preset reference variation rate value means a variation rate of an electrical signal corresponding to an optical signal reflected by a reference mark formed on the optical disc when the optical spot is accurately focused on the information recording surface of the optical disc.

When a focus control method in accordance with the present invention is applied to a near field (NF) optical pick-up system, the optical beam may be focused on the information recording surface of the optical disc by fixing the objective lens 7 and moving the collimator lens 3 right and left through an actuator (not shown) mounted at the collimator lens 3. For example, the pick-up system 27 may accurately focus an optical beam on an information recording surface of the optical disc by moving the collimator lens 3 right and left through an actuator mounted at the collimator lens 3 according to a control signal of the system controller 24 without moving the objective lens 7 so that a variation rate of an electrical signal corresponding to an optical signal reflected by a reference mark formed on the optical disc 9 is not smaller than a preset reference variation value.

Accordingly, in the present invention, it is most desirable to control a focus of an optical pick-up system by irradiating an optical beam onto an optical disc on which a reference mark is formed and moving the collimator lens 3 or the objective lens 7 on the basis of an optical signal reflected by the reference mark of the optical disc.

In addition, in the present invention, an optical disc drive to which an optical pick-up system in accordance with the present invention is mounted can accurately record data on the optical disc or reproduce data of the optical disc because the optical pick-up system in accordance with the present invention can accurately control a focus regardless of a kind of optical disc mounted to an optical pick-up system.

As so far described, in the present invention, even if a component of an optical pick-up system is defective, an assembling error occurs, or a thickness of an optical disc is not uniform, a focus of an optical pick-up system can be accurately controlled on the basis of an optical signal reflected by a reference mark formed on the optical disc. That is, by accurately focusing an optical spot of an optical beam on an information recording surface of the optical disc on the basis of an optical signal reflected by a reference mark formed on the optical disc, data can be accurately recorded on the optical disc, or the data of the optical disc can be accurately reproduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A focus control method of an optical pick-up system comprising:
irradiating an optical beam onto an optical recording media having a reference mark through an objective lens of an optical pick-up system; and
moving the objective lens or a collimator lens of the optical pick-up system on the basis of an optical signal reflected by the reference mark of the optical recording media.

2. The method of claim 1, wherein the step of moving the objective lens or the collimator lens is a step of focusing the optical beam on an information recording surface of the optical recording media by moving the objective lens or the collimator lens of the optical pick-up system on the basis of the optical signal.

3. The method of claim 1, wherein, in the step of moving the objective lens or the collimator lens, the objective lens is moved up and down on the basis of the optical signal, or the collimator lens is moved right and left on the basis of the optical signal.

4. The method of claim 1, wherein, in the step of moving the objective lens or the collimator lens, the objective lens is moved up and down so that a value of an electrical signal corresponding to the optical signal is equal to or greater than a preset reference value, or the collimator lens is moved right and left so that a value of an electrical signal corresponding to the optical signal is equal to or greater than the preset reference value.

5. The method of claim 1, wherein, in the step of moving the objective lens or the collimator lens, the objective lens is moved up and down so that a variation value of a voltage corresponding to the optical signal is equal to or greater than a preset reference variation rate value, or the collimator lens is moved right and left so that a variation rate of a voltage corresponding to the optical signal is equal to or greater than a predetermined reference variation rate value.

6. The method of claim 1, wherein the reference mark is a record pattern formed radially on the information recording surface of the optical recording media.

7. The method of claim 1, wherein the reference mark is a record pattern formed such that its reflectivity is high and low alternately.

8. The method of claim 1, wherein the optical recording media is a ROM disc, and the reference mark is a recording pattern formed such that bright and dark regions are formed alternately and is formed on one portion of the ROM disc.

9. A focus control method of an optical pick-up system comprising:
positioning an optical recording medial on which a reference mark is formed under an objective lens of an optical pick-up system;
irradiating an optical beam onto the optical recording media through the objective lens while rotating the optical recording media;
analyzing an optical signal reflected by a reference mark of the optical recording media; and
focusing the optical beam on an information recording surface of the optical recording media by moving the objective lens or a collimator lens of the optical pick-up system on the basis of the analyzed optical signal.

10. The method of claim 9, wherein the reference mark is record patterns formed radially on one portion of the information recording surface of the optical recording media.

11. The method of claim 10, wherein the reference mark is record patterns formed such that their magnetization direction is upward and downward alternately.

12. The method of claim 10, wherein the reference mark is record patterns formed such that their reflectivity is high and low alternately.

13. The method of claim 9, wherein the optical recording media is a ROM disc, and the reference mark is record patterns formed such that bright and dark regions are alternately formed, and is formed on one portion of the ROM disc.

14. The method of claim 9, wherein the collimator lens is moved by an actuator mounted to the collimator lens.

15. The method of claim 9, wherein, in the step of focusing the optical beam on the information recording surface of the optical recording media, the objective lens is moved up and down, or the collimator lens is moved right and left, so that a variation rate of an electrical signal corresponding to an optical signal reflected by the reference mark is equal to or greater than a preset reference variation rate value.

16. A focus control method of an optical pick-up system comprising:
positioning an optical disc having a reference mark formed radially under an objective lens of an optical pick-up system;
irradiating an optical beam onto the optical disc through the objective lens while rotating the optical recording media;
determining whether an optical signal reflected by the reference mark of the optical disc is normal;
determining the optical signal to be normal if a variation rate of an electrical signal corresponding to the optical signal is equal to or greater than a preset reference value; and
moving the objective lens up and down, or moving the collimator lens of the optical pick-up system right and left if the variation rate of an electrical signal corresponding to the optical signal is smaller than the preset reference variation rate value, so that a variation rate of an electrical signal corresponding to the optical beam becomes equal to or greater than the preset reference variation rate value.

17. An optical pick-up system installed at an optical disc drive for recording/reproducing an optical recording media and having a laser diode, a collimator lens, a beam splitter, a mirror, an objective lens and a solid immersion lens, comprising:
a controller for generating a control signal for moving the collimator lens so that a variation rate of an electrical signal corresponding to an optical signal reflected by a reference mark formed on the optical recording media is equal to or greater than a preset reference variation rate value; and
an actuator for moving the collimator lens according to the control signal.

18. The system of claim 17, wherein the actuator is mounted at the collimator lens and moves the collimator lens right and left according to the control signal.

19. A focus control apparatus of an optical pick-up system comprising:
a controller for generating a control signal for moving a collimator lens of an optical pick-up system so that a value of an electrical signal corresponding to an optical signal reflected by a reference mark formed on an optical recording media is equal to or greater than a preset reference value; and
an actuator for moving the collimator lens according to the control signal.
